(19) United States
(12) Patent Application Publication
(10) Pub. No.: US 2019/0008274 A1
(43) Pub. Date: Jan. 10, 2019

(54) MEDICAL SOLUTION CABINET

(71) Applicant: FireKing Security Products, LLC., New Albany, IN (US)

(72) Inventors: Will Wolf, Davenport, IN (US); Trista Walk, New Salisbury, IN (US); Bryan Mills, Mt. Washington, KY (US)

(21) Appl. No.: 16/030,581

(22) Filed: Jul. 9, 2018

Related U.S. Application Data
(60) Provisional application No. 62/530,542, filed on Jul. 10, 2017.

(51) Int. Cl. A47B 67/02; E05C 9/00; E05B 51/00; E05B 47/00

(52) U.S. Cl. CPC A47B 67/02; E05B 47/0001; E05B 51/00; E05C 9/00

(57) ABSTRACT

A medical solution cabinet is contemplated for limiting child-medication errors resulting from school personnel inadvertently selecting an improper medication for dispensation to a student. The solution may enable school personnel to properly associate medications with individual students using an organization system whereby medications are secured, arranged and retrieved alphabetically according to individual student names.

### CROSS-REFERENCE TO RELATED APPLICATIONS

This application claims the benefit of U.S. provisional Application No. 62/530,542 filed Jul. 10, 2017, the disclosure of which is incorporated in its entirety by reference herein.

### TECHNICAL FIELD

The present invention relates to a medical solution cabinet for limiting child-medication errors resulting from school personnel inadvertently selecting an improper medication for dispensation to a student.

### BACKGROUND

Many U.S. schools have reported child-medication errors associated with school personnel inadvertently selecting an improper medication for dispensation to a student. Overworked staff, budget cuts that eliminate school nurses, complicated medication schedules and other factors may contribute to an environment in schools where mistakes can happen. One non-limiting aspect of the present invention contemplates a medical solution cabinet for limiting such child-medication errors by enabling school personnel to properly associate medications with individual students using an organization system whereby medications are secured, arranged and retrieved alphabetically according to individual student names.

### BRIEF DESCRIPTION OF THE DRAWINGS

FIGS. 1-2 illustrate a medical solution cabinet in accordance with one non-limiting aspect of the present invention.

FIG. 3 illustrates a medication administration log, one of the medical storage bags and one of the discs in accordance with one non-limiting aspect of the present invention.

FIGS. 4-5 illustrate a medical solution in accordance with one non-limiting aspect of the present invention.

FIGS. 6-7 illustrate a medical solution in accordance with one non-limiting aspect of the present invention.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

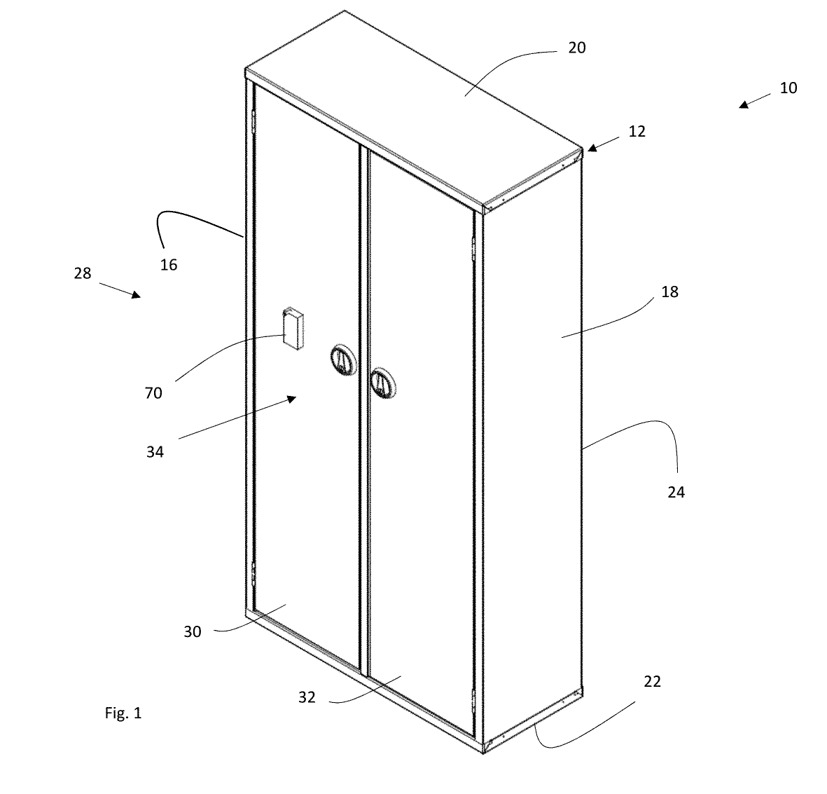

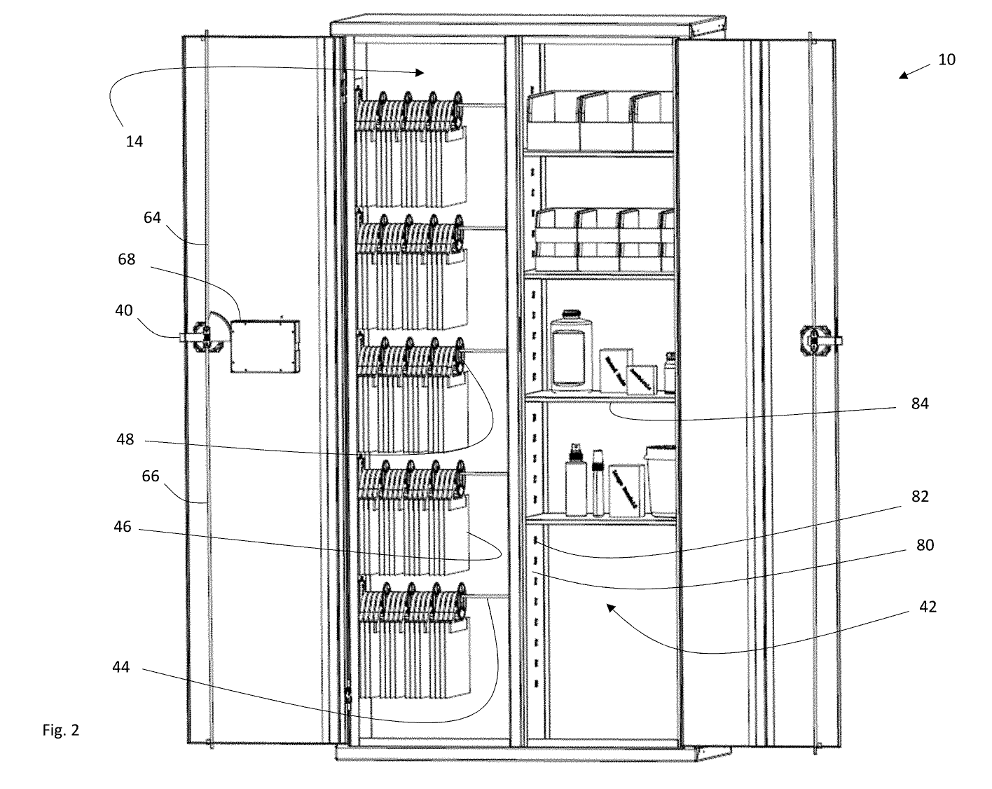

FIGS. 1-2 illustrate a medical solution cabinet 10 for limiting child-medication errors resulting from school personnel inadvertently selecting an improper medication for dispensation to a student in accordance with one non-limiting aspect of the present invention. The cabinet 10 may include a housing 12 having a plurality of walls arranged to provide a secure storage area 14. The plurality of walls may include a first sidewall 16, a second sidewall 18, a top wall 20, a bottom wall 22 and a back wall 24. The back wall 24 may adjoin a rearward side of each of the first, second, top and bottom walls 16, 18, 20, 22. The first sidewall 16 may be horizontally spaced apart from the second sidewall 18, and the top wall 20 may be vertically spaced apart from the bottom wall 22.

The cabinet 10 may include a door assembly 28 including a first door 30, a second door 32 and a locking mechanism 34. The first door 30 may be rotatably affixed to a forward side of the first sidewall 16, and the second door 32 may be rotatably affixed to a forward side of the second sidewall 18. The first and second doors 30, 32 may be rotatable between a closed position (FIG. 1) and an opened position (FIG. 2) to control access to the secure storage area. The locking mechanism 34 may include a lock 40 actuatable between a locked position and an unlocked position to control movement of the first and second doors 16, 18 from the closed position to the opened position.

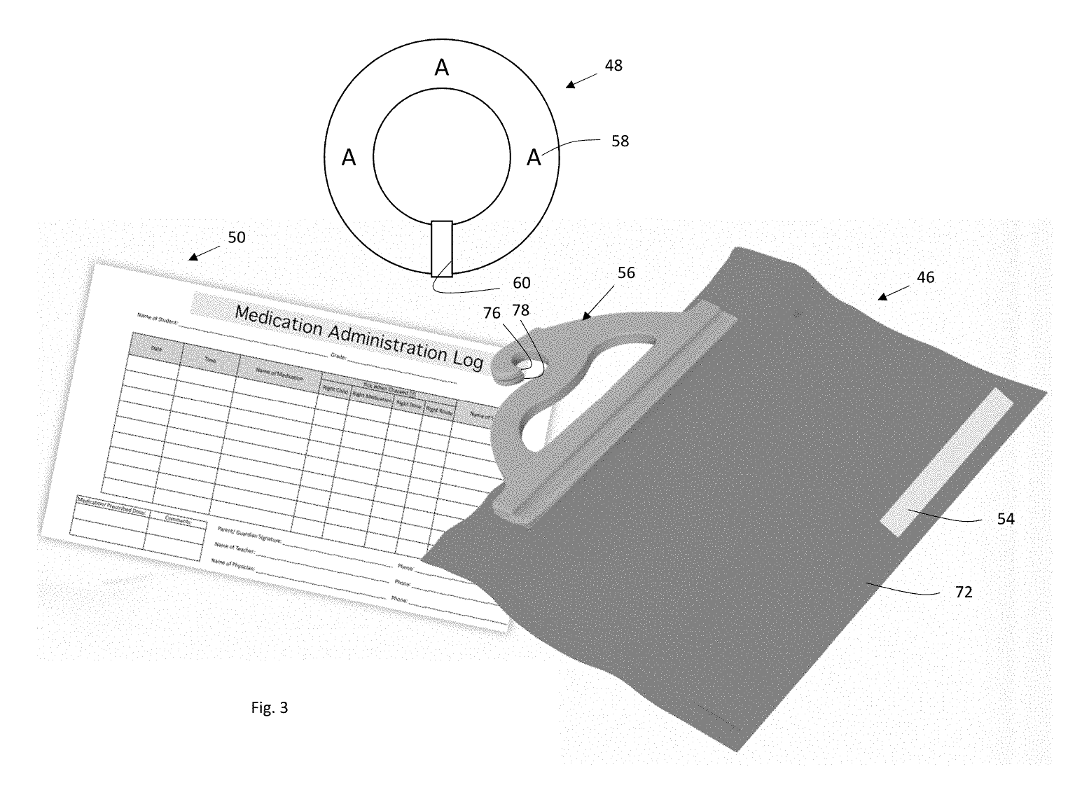

The cabinet 10 may include a medical solution assembly 42 included within the secure storage area 14. The medical solution assembly 42 may include a plurality of hanger bars 44, a plurality of medication storage bags 46 and a plurality of discs 48. The plurality of hanger bars 44 may be horizontally elongated bars affixed to at least one of the first and second sidewalls 16, 18. FIG. 3 illustrates a medication administration log 50, one of the medical storage bags 46 and one of the discs 48 in accordance with one non-limiting aspect of the present invention. The plurality of medication storage bags 46 may include a label 54 sufficient for marking with an indicia of a student associated therewith and a hook 56 for releasably attaching to one of the hanger bars 44. The plurality of discs 48 may each include a character designation 58 and an opening 60 for releasably attaching to one of the hanger bars. The plurality of discs 48 may be sufficient to individually indicate each letter of the alphabet with one of the character designations 58 such that enough of the plurality of discs 48 are included to alphabetically divide each of the plurality of storage bags 46 according to the indicia of the student associated therewith.

The medical administration log 50 may be included within each of the storage bags 46 to indicate when corresponding medication was dispensed to a student. The log may include field for listing the name of a student, grade, date, time, name of medication, parent/guardian signature, name of teacher, name of physician, phone numbers for all names, prescription dosage and comments as well as fields for marking that the dosage was provided to the right child, with the right medication, with the right dose and with the right route.

The locking mechanism 34 may include an upper lock rod 64 and a lower lock rod 66. The upper and lower lock rods 64, 66 may be actuatable respectively in and out of the top wall and the bottom wall 20, 22 to facilitate securing access to the secure storage area 14. The upper and lower lock rods 64, 66 may be journaled within the top and bottom walls 20, 22 when the locking mechanism 34 is in the locked position and the first and second doors 30, 32 are in the closed position. The locking mechanism 34 may include an electronically operable swing bolt 68 actuatable between a blocked position and an unblocked position. The blocked position may prevent the upper and lower lock rods 64, 66 from disengaging the top and bottom walls 20, 22. The unblocked position may permit the upper and lower lock rods 64, 66 to disengage the top and bottom walls 20, 22. The locking mechanism 34 may include a card reader 70 for facilitating electro-mechanically actuation of the swing bolt 68 from the blocked position to the unblocked position. The locking mechanism 34 may additionally or alternatively include a facial recognition device 70 for facilitating electro-mechanically actuation of the swing bolt from the blocked position to the unblocked position.

The plurality of storage bags 46 each may include a flexible storage 72 compartment with a handle having connectable halves 76, 78 to facilitate a clasp or a seal sufficient for sealing medication stored therein when attached to one of the hanger bars 44. The plurality of storage bags 46 may each include the medication administration log 50 therein having the plurality of entry fields for marking dispensation of a medication stored therein.

The medical solution assembly 42 may include a divider 80 for vertically separating the secure storage area into a first half and a second half. The plurality of hanger bars 44 may be positionable within a plurality of reliefs 82 vertically spaced along a length of the divider. The medical solution assembly 42 may include a plurality of shelves 84 positionable with the plurality of reliefs 82. The plurality of hanger bars 44 may be entirely positioned in the first half of the secure storage area 14 with the plurality of shelves 84 being entirely positioned in the second half of the secure storage area 14 as illustrated.

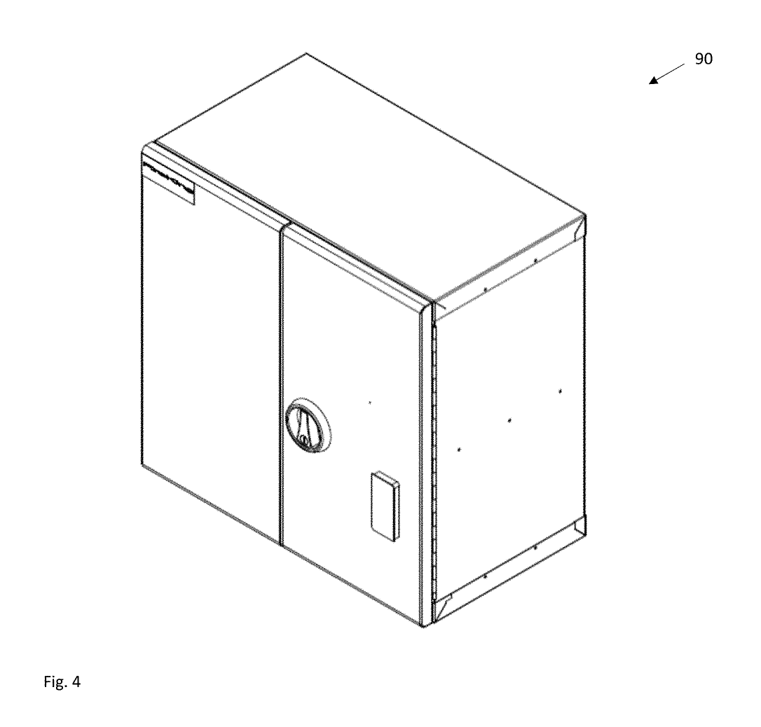

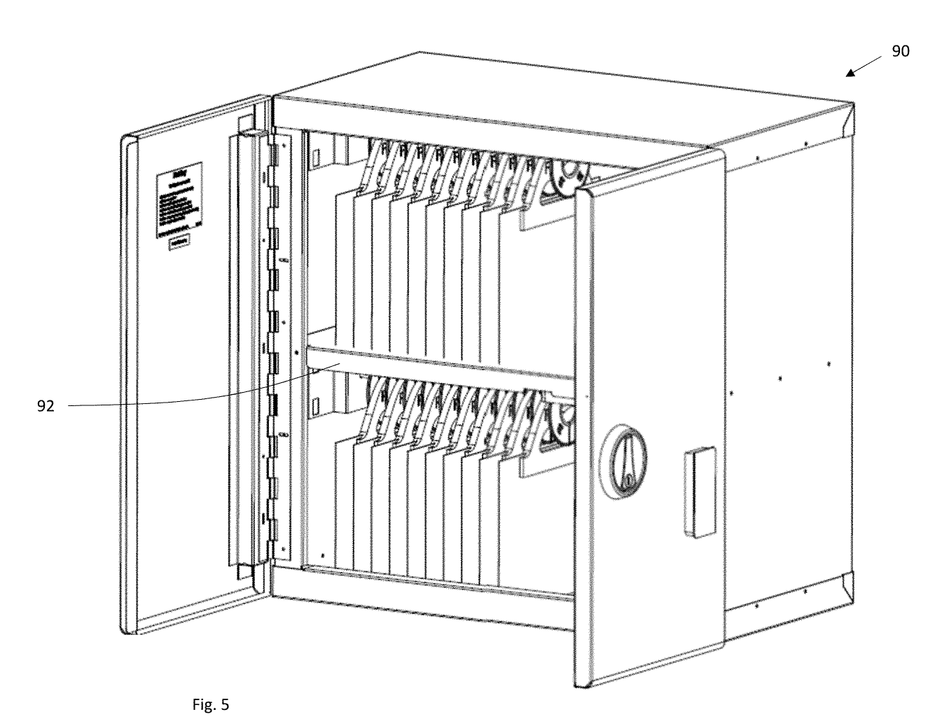

FIGS. 4-5 illustrates a medical solution cabinet 90 for limiting child-medication errors resulting from school personnel inadvertently selecting an improper medication for dispensation to a student in accordance with one non-limiting aspect of the present invention. The cabinet 90 is illustrated for exemplary purposes as including a divider 92, shown as a shelf extending across an entire cross-section of the secure storage area, for horizontally separating the secure storage area into a first half and a second half. A first hanger bar and a second hanger bar may be secured at one end to a first sidewall and at another and to a second sidewall.

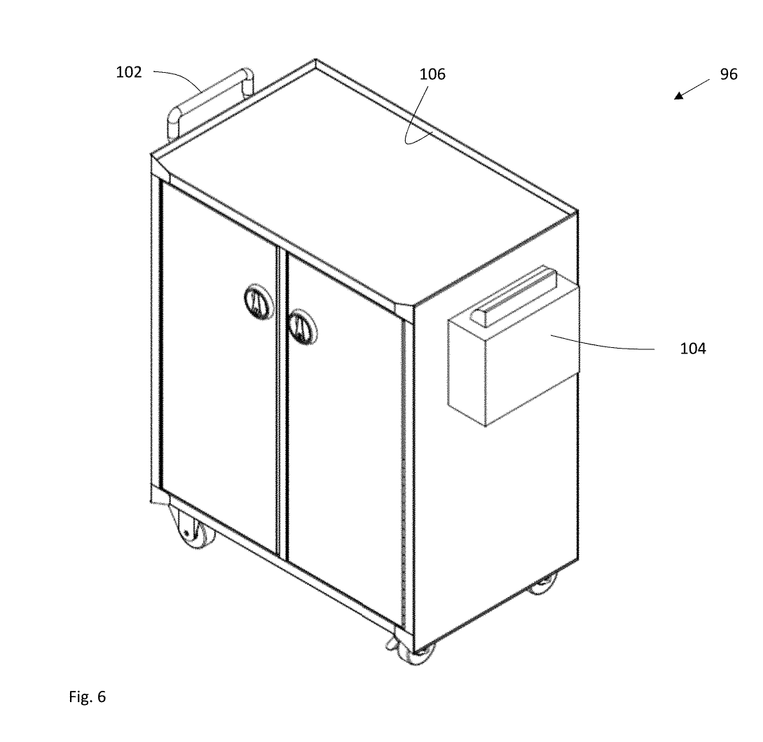

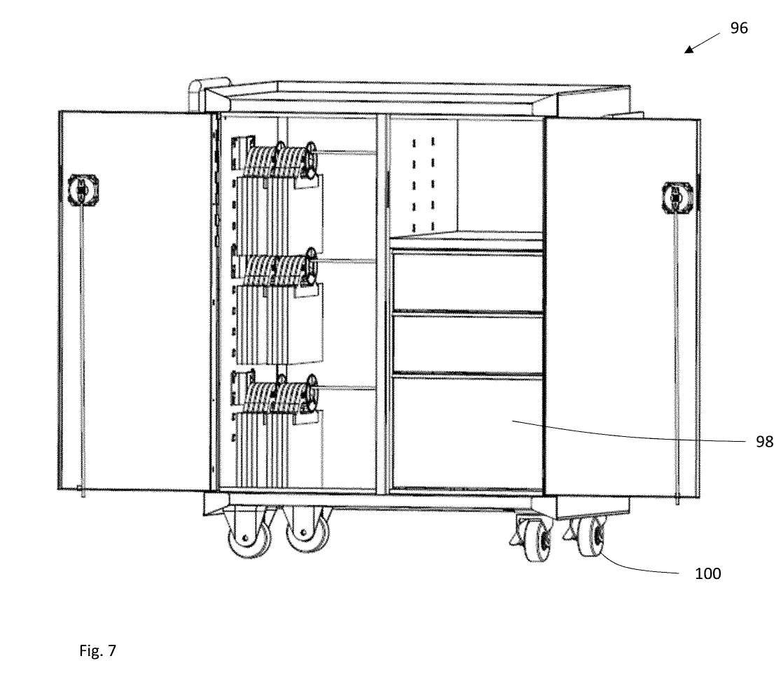

FIGS. 6-7 illustrates a medical solution cabinet 96 for limiting child-medication errors resulting from school personnel inadvertently selecting an improper medication for dispensation to a student in accordance with one non-limiting aspect of the present invention. The cabinet 96 is illustrated for exemplary purposes as including a plurality of drawers 98 within the second half of the secure storage area operable to slide out of the secure storage area when a second door is in the opened position. The cabinet 96 may include a plurality of casters 100 affixed to a bottom wall and a handle 102 affixed to an exterior of a first sidewall to cooperatively facilitate movement of the cabinet 96. The cabinet 96 may include a tray 104 having an opening for securing papers therein during movement of the cabinet 96 affixed to an exterior of the second sidewall. The cabinet may include an exterior of a top wall with a raised rim 106 to facilitate securing items thereon during movement of the cabinet.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A medical solution cabinet for limiting child-medication errors resulting from school personnel inadvertently selecting an improper medication for dispensation to a student, the medical solution cabinet comprising:
a housing including a plurality of walls arranged to provide a secure storage area, the plurality of walls including a first sidewall, a second sidewall, a top wall, a bottom wall and a back wall, the back wall adjoining a rearward side of each of the first, second, top and bottom walls and the first sidewall being horizontally spaced apart from the second sidewall and the top wall being vertically spaced apart from the bottom wall;
a door assembly including a first door, a second door and a locking mechanism, the first door being rotatably affixed to a forward side of the first sidewall and the second door being rotatably affixed to a forward side of the second sidewall, the first and second doors being rotatable between a closed position and an opened position to control access to the secure storage area, the locking mechanism including a lock actuatable between a locked position and an unlocked position to control movement of the first and second doors from the closed position to the opened position; and
a medical solution assembly included within the secure storage area, the medical solution assembly including a plurality of hanger bars, a plurality of medication storage bags and a plurality of discs, the plurality of hanger bars being horizontally elongated bars affixed to at least one of the first and second sidewalls, the plurality of medication storage bags including a label sufficient for marking with an indicia of a student associated therewith and a hook for releasably attaching to one of the hanger bars, the plurality of discs each including a character designation and an opening for releasably attaching to one of the hanger bars, the plurality of discs being sufficient to individually indicate each letter of the alphabet with one of the character designations such that one of the plurality of discs alphabetically divides each of the plurality of storage bags according to the indicia of the student associated therewith.

2. The cabinet of claim 1 wherein the locking mechanism includes an upper lock rod and a lower lock rod, the upper and lower lock rods being actuatable respectively in and out of the top wall and the bottom wall to facilitate securing access to the secure storage area, the upper and lower lock rods being journaled within the top and bottom walls when the locking mechanism is in the locked position and the first and second doors are in the closed position.

3. The cabinet of claim 2 wherein the locking mechanism includes an electronically operable swing bolt actuatable between a blocked position and an unblocked position, the blocked position preventing the upper and lower lock rods from disengaging the top and bottom walls and the unblocked position permitting the upper and lower lock rods to disengage the top and bottom walls.

4. The cabinet of claim 3 wherein the locking mechanism includes a card reader for facilitating electro-mechanically actuation of the swing bolt from the blocked position to the unblocked position.

5. The cabinet of claim 3 wherein the locking mechanism includes a facial recognition device for facilitating electro-mechanically actuation of the swing bolt from the blocked position to the unblocked position.

6. The cabinet of claim 1 wherein the plurality of storage bags each includes a flexible storage compartment with a seal sufficient for sealing medication stored therein when attached to one of the hanger bars.

7. The cabinet of claim 6 wherein the plurality of storage bags each includes a medication administration log having a plurality of entry fields for marking dispensation of a medication stored therein.

8. The cabinet of claim 7 wherein the medical solution assembly includes a divider for vertically separating the secure storage area into a first half and a second half, the plurality of hanger bars being positionable within a plurality of reliefs vertically spaced along a length of the divider.

9. The cabinet of claim 8 wherein the medical solution assembly includes a plurality of shelves positionable with the plurality of reliefs.

10. The cabinet of the claim 9 wherein the plurality of hanger bars are entirely positioned in the first half of the secure storage area and the plurality of shelves are entirely positioned in the second half of the secure storage area.

11. The cabinet of claim 10 wherein the medical solution assembly includes a plurality of drawers within the second half of the secure storage area, the plurality of drawers being slideable out of the secure storage area when the second door is in the opened position.

12. The cabinet of claim 11 further comprising a plurality of casters affixed to the bottom wall and a handle affixed to an exterior of the first sidewall, the plurality of casters cooperating with the handle to facilitate movement of the cabinet.

13. The cabinet of claim 12 further comprising a tray affixed to an exterior of the second sidewall, the tray including an opening for securing papers therein during movement of the cabinet.

14. The cabinet of claim 13 wherein an exterior of the top wall includes a raised rim to facilitate securing items thereon during movement of the cabinet.

15. The cabinet of claim 7 wherein the medical solution assembly includes a divider for horizontally separating the secure storage area into a first half and a second half.

16. The cabinet of claim 15 wherein the plurality of hanger bars consists of a first hanger bar and a second hanger bar, the first and second hanger bars being secured at one end to the first sidewall and at another and to the second sidewall, the first hanger bar being positioned above the divider and the second hanger bar being positioned below the divider.

17. The cabinet of claim 16 wherein the divider is a shelf.
